(19) United States
(12) Patent Application Publication
(10) Pub. No.: US 2003/0142350 A1
(43) Pub. Date: Jul. 31, 2003

(54) Control of multipart print jobs

(76) Inventor: Jeremy John Carroll, Livorno (IT)

Correspondence Address: HEWLETT-PACKARD COMPANY, Intellectual Property Administration, P.O. Box 272400, Fort Collins, CO, 80527-2400, US

(21) Appl. No.: 10/346,343

(22) Filed: Jan. 17, 2003

(30) Foreign Application Priority Data
Jan. 25, 2002 (GB) 0201635.0

(51) Int. Cl. G06F 15/00; B41J 1/00

(52) U.S. Cl. 358/1.15

(57) ABSTRACT

The present invention relates to a method and a system for controlling multipart print jobs in a printing system having one or more printers connected to a computer system. The computer system has a display (20) for presenting to a user of the system status information (124,125,126,130,131) regarding one or more print jobs (24,25,26) at least one of which (24,26) is split into a plurality of parts (30,31). The parts of the print job are sent to one or more of the printers for printing, and status information (124,125,126,130,131) regarding the print job is displayed on the display. The status information comprises a master status control indicator (124,125,126) for each print job (24,25,26) and associated with the master status control indicator (124,125,126) a plurality of sub-status control indicators (130,131), one for each of the parts (30,31) of the corresponding print job (24), so that a user of the printing system can control both the overall status of the print job (24,25,26) and the status of each of the parts (30,31) of the corresponding print job (24).

### BACKGROUND

a. Field of the Invention

The present invention relates to a method and a system for controlling multipart print jobs in a printing system having one or more printers connected to a computer system.

b. Related Art

A multipart print job is one with a number of sub-parts that can be printed independently of one another. In some cases, such splitting of an overall print job is necessary because printers have different printing capabilities. For example, one printer may be a black and white laser printer loaded with A4 and A3 size paper, while another may be an ink jet printer loaded with A5 size glossy photograph paper. If a print job requires both A4 black and white laser printing and A5 color ink jet printing, then the print job will have to be split across both printers. On the other hand, if a print job requires the A4 laser printer to be manually or automatically reconfigured for a sub-part of the print job, for example by loading A4 transparency stock, then the print job may be split at the point where reconfiguration is required.

It is common for such printers to be on a network connected to one or more computers. It is known for printer software to display printer status and to allow control of the printer status on a computer display. The printer status is then shown along with a queue for each print job assigned to each printer. This is convenient in the case of a single computer connected to a single printer. When more than one printer is connected to the computer, then each printer will have its own software from which the status for each print job sent to each printer is displayed separately, for example in a separate window on the display. It then becomes more difficult to control and to view the status of a split print job, because the print status information is displayed separately.

This problem is much worse when a number of different computers are connected to one or more printers, because different print jobs from different computers may all be shown in each of the separate queues. It then becomes very difficult to view and control the different sub-parts of a split print job.

### SUMMARY OF THE INVENTION

It is an object of the present invention to provide a more convenient way of controlling such a multipart print job.

According to a first aspect invention, there is provided a method of printing a print job in a printing system, the printing system comprising one or more printers and a computer system, the computer system being connected to the printers, wherein the computer system has a display for presenting to a user of the printing system print job status information, wherein the method comprises the steps of:

i) using the computer system to generate a multipart print job, said multipart print job being split into a plurality of sub-parts;

ii) sending the sub-parts of the multipart print job to one or more of the printers for printing; and

iii) displaying on the display, print job status information regarding the multipart print job;

wherein the print job status information comprises a master status control indicator for each multipart print job and associated with the master status control indicator a plurality of sub-status control indicators, one for each of the associated sub-parts of the multipart print job, so that a user of the printing system can control both the overall status of the print job and the status of each of said associated sub-parts.

According to a second aspect of the invention, there is provided a method of printing a print job in a printing system, the printing system comprising one or more printers and a computer system, the computer system being connected to the printers and having a user display and the method comprises the steps of:

i) using the computer system to generate at least one print job including at least one multipart print job, said multipart print job being split into a plurality of sub-parts;

ii) sending the sub-parts of the multipart print job to one or more of the printers for printing; and

iii) displaying status information regarding said at least one print job on the display;

wherein the status information comprises: a master status control indicator showing the overall status of the or each print job; and for the or each multipart print job a plurality of sub-status control indicators associated with a corresponding master status control indicator.

According to a third aspect of the invention, there is provided a method of controlling multipart print job printing in a printing system, the printing system comprising one or more printers and a computer system, the computer system being connected to the printers, wherein the computer system has a display for presenting to a user printer status information, wherein the method comprises the steps of:

i) using the computer system to generate at least one multipart print job, said multipart print job being composed of a plurality of sub-parts;

ii) sending said sub-parts of the multipart print job to one or more of the printers for printing; and

iii) displaying on the display, status information regarding the multipart print job, wherein the status information comprises a user-interactive master status control indicator for the or each multipart print job and associated with the or each master status control indicator a plurality of user-interactive sub-status control indicators, one for each of the associated sub-parts of the multipart print job;

iv) using the computer system to control the printing of at least one multipart print job via an associated master status control indicator and/or via an associated sub-status control indicator.

According to a fourth aspect of the invention, there is provided a method of printing multipart print jobs in a printing system, the printing system comprising one or more printers and a computer system, the computer system being connected to the printers, wherein the computer system has a user display, wherein the method comprises the steps of:

i) using the computer system to generate the multipart print job, said multipart print job being split into a plurality of sub-parts;

ii) sending the sub-parts of the multipart print job to one or more of the printers for printing; and

iii) displaying on the user display status information regarding the multipart print job, said status information comprising a master status control indicator for the multipart print job and a plurality of sub-status control indicators, one for each of said sub-parts, wherein each of said sub-status control indicators is graphically associated on the user display with the master status control indicator.

The computer system may in general include a user-operable control input device, for example, a computer mouse, keyboard, touch screen, or speech recognition system, or other such data input device. The status control indicators for the print job and associated sub-parts may then each include a control function, the control functions being responsive to the control input device so that a user of the printing system may control the print job via the control input device.

The control of the entire print job, or of the sub-parts of the print job, may then be performed by the user, either via the computer system, or directly via the or each printer.

Because the master status control indicator and sub-status control indicators are associated with each other, a user of the system can then conveniently view and control the print job status, either via the master status control indicator, or via any or all of the sub-status control indicators. For example, the master status control indicator could be used to cancel or to pause the complete print job, or just one of the sub-status control indicators could be used to cancel or to restart one of the print job sub-parts.

It will be most convenient if the various control indicators are grouped together in one area of the display, so that the user may at a glance view or control the print status, either of the print job in total, or each individual sub-part of the print job.

Preferably, the control functions are each responsive to the control input device such that the overall print job and the associated sub-parts of the print job are all independently controllable by the user.

Each control function may be capable of any or all of: starting, pausing, cancelling, or re-starting the print job or sub-part of the print job associated with each control function.

Each of the status control indicators may also indicate any or all of: whether the associated print job has started; whether the associated print job or sub-part of the print job is pending; whether the associated print job or sub-part of the print job has finished.

Also according to the invention, there is provided a printing system comprising one or more printers and a computer system, the computer system being connected to the printers, the computer system having a user display for presenting to a user of the system status information regarding a print job, wherein the computer system is operable to:

a) generate one or more print jobs at least one of which is a multipart print job split into a plurality of sub-parts;

b) send said sub-parts of the multipart print job to one or more of the printers for printing; and

c) display on the user display status information regarding said generated print job(s);

wherein the status information comprises a master status control indicator for the or each print job and associated with the master status control indicator of a multipart print job a plurality of sub-status control indicators, one for each of the sub-parts of the corresponding multipart print job.

According to a further aspect of the invention, there is provided a printing system comprising one or more printers and a computer system, the computer system being connected to the printers, the computer system having a user display for presenting to a user of the system status information regarding a print job, and a user-operable control device, wherein the computer system is operable to:

a) generate at least one multipart print job, said multipart print job being composed of a plurality of sub-parts;

b) send said sub-parts of the multipart print job to one or more of the printers for printing;

c) display on the user display status information regarding said multipart print job(s), wherein the status information comprises a user-interactive master status control indicator for the or each multipart print job and associated with the or each master status control indicator a plurality of user-interactive sub-status control indicators, one for each of the associated sub-parts of the multipart print job;

d) in response to user-operable control device, to control the printing of at least one multipart print job via an associated master status control indicator and/or via an associated sub-status control indicator.

### BRIEF DESCRIPTION OF THE DRAWINGS

The invention will now be described in further detail, and by way of example only, with reference to the accompanying drawings, in which:

FIG. 1 is a view of a printing system according to the invention, showing several printers connected to computers via a computer network, each computer having a user display;

FIG. 2 is a view of one of the user displays of FIG. 1, showing control status indicators for a single part print job and two multipart print jobs submitted to the printers; and

FIG. 3 is a flow chart showing how the printer system according to the invention can be used to control the print job.

### DETAILED DESCRIPTION OF THE PREFERRED EMBODIMENT

FIG. 1 shows schematically a printing system 1 having several personal computers 2,3,4 each of which is connected 6 to a local area network 8. Also connected 9 to the network 8 are several printers 10,11,12, each of which has one or more trays 13 that can be loaded with various types and sizes of paper, transparencies, envelopes, or other types of feedstock (not shown).

Each computer 2,3,4 has a system unit 14 to which is connected a user display 15, and input devices such as a keyboard 16 and a mouse 17.

Software running in each system unit 14 enables a user to send print jobs via the network 8 to one or more of the printers 10,11,12. The software includes printer drivers and a management information base (MIB) that describes each of the printers' 10,11,12 print capabilities. The print capabilities include both configurable and non-configurable features of the printer. An example of a configurable feature of a printer would be a paper tray which can be loaded with either A4 size or A3 size paper. An example of a non-configurable feature would be black and white laser printing capability or ink-jet color printing capability.

The requirement of some print jobs may be satisfied by just one type of printer capability, for example a print job consisting only of black and white laser A4 sized paper. The present invention is concerned mainly with those cases in which at least one print job has requirements that are satisfied by different printer capabilities, for example a print job consisting of a mix of A4 and A3 sized paper, or a print job consisting of both black and white laser prints and color ink jet prints. Application of the invention is however not limited to such cases—it may be used, for example, in cases where the document is large and an early completion time is required or desirable (or where resources are generally available now but may become scarce at a later point).

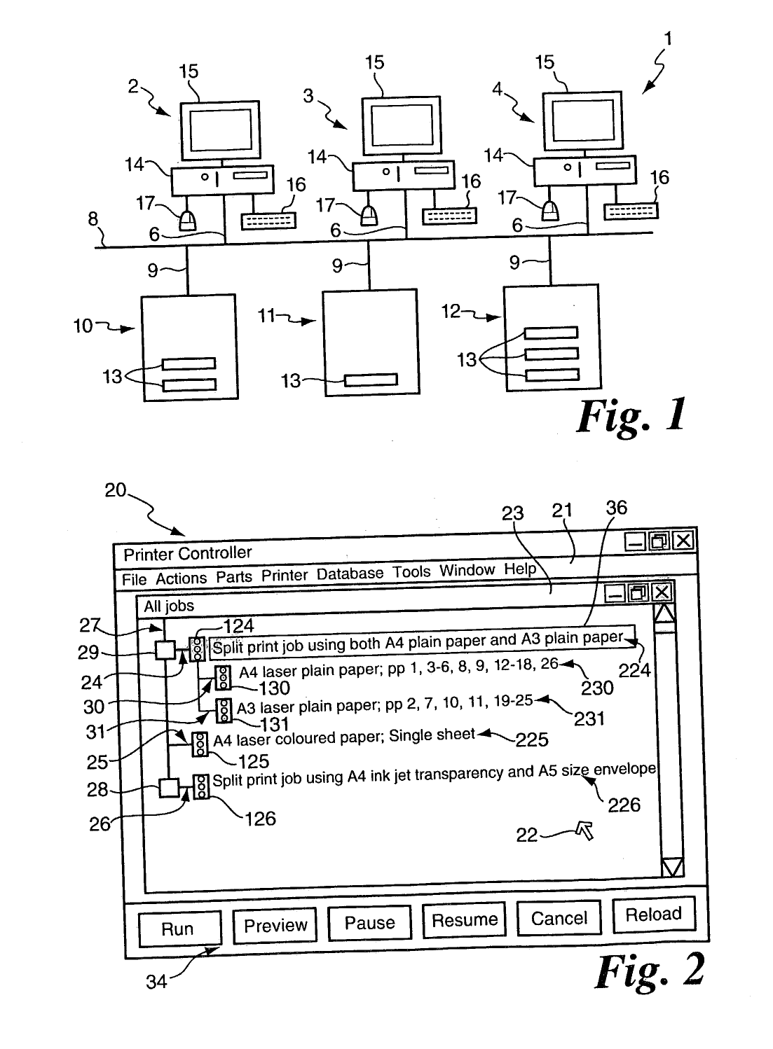

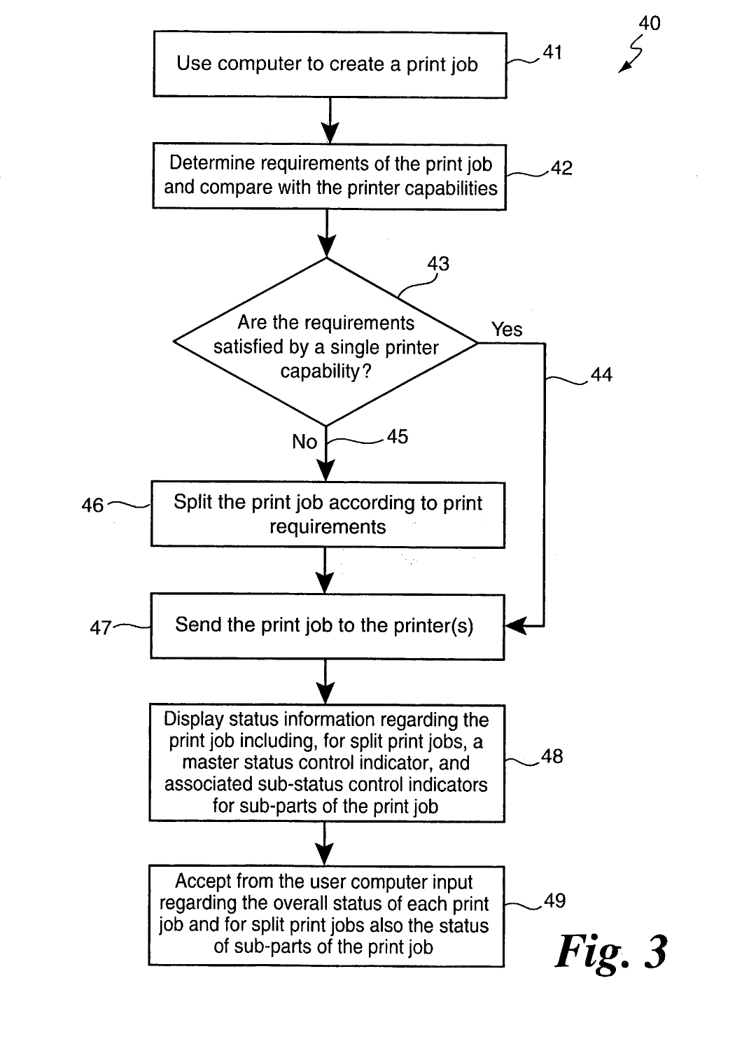

FIG. 2 shows how system status information regarding several print jobs is displayed within a “Printer Controller” window 20 on the user display 15, and FIG. 3 shows a flow chart 40 that illustrates the steps leading to the generation of the system status information on the display 15.

The Printer Controller window 20 has a command bar 21 with a number of functions that a user can select in the normal way using a mouse cursor 22 to cause a drop down menu to appear (not shown). The “Printer” drop down menu has one function, “All jobs” which when selected causes an “All jobs” window 23 to appear within the Printer Controller window 20.

The “All jobs” window is illustrated showing three print jobs 24,25,26 within a print queue 27. The print jobs 24,25,26 are displayed sequentially in the queue 27 according to the order in with jobs are submitted for printing. Here, the earlier submitted print jobs are displayed above the later submitted print jobs.

When a print job is split, it is displayed joining the print queue 27 at a box symbol 28,29, which either encloses a “plus” symbol as in the case of print job 26 where sub-parts of the print job are not shown, or enclosing a “minus” symbol as in the case of print job 24 where sub-parts 30,31 of the print job are shown. The boxes 28,29 may be toggled between “plus” and “minus” symbols upon a click of the mouse cursor 22.

As shown in FIG. 2, print jobs 24 and 26 are split print jobs, while print job 25 is not a split job. Print job 24 is split into two sub-parts, one of which 30 is to print pages “1, 3-6, 8, 9, 12-18, 26” on A4 size plain paper using a laser printer, and the other of which 31 is to print pages “2, 7, 10, 11, 19-25” on A3 size plain paper using a laser printer.

The system status information is shown on the user display 15 in the forma of one master status control indicator 124,125,126 for associated each print job 24,25,26. Where a print job has been split, a plurality of sub-status control indicators 130,131 are displayed in “tree” form when a box 28,29 has been toggled to a “plus” sign. Thus a master status control indicator is graphically associated with associated sub-status control indicators.

Each of the various status control indicators 124,125,126,130,131 for the print job 24,25,26 and associated sub-parts 30,31 preferably includes an indication as to whether or not a print job has started, and whether or not a started print job has finished. In this example, each print job 24,25,26, and each sub-part 30,31 of a split print job 24,26 has an associated status control indicator 124,125,126,130,131 in the form of a traffic light. This may have red, green and amber indications indicating respectively that the print job is stopped, in progress or paused.

For convenience, a number of the more commonly used functions in the control bar 21, such as “Run”, “Preview”, “Pause”, “Resume”, “Cancel” and “Reload” are provided as soft keys 34 along the base of the “Printer Controller” window 20.

As shown in FIG. 2, the arrangement of the print jobs 24,25,26 and sub-parts of the print jobs 30,31, is such that the status information is displayed in the form of a tree view, with descriptive text 224,225,226,230,231 extending to the right of the status indicators 124,125, 126,130,131. The descriptive text is surrounded by a “soft button” which can be selected and highlighted by the mouse cursor 22, as shown for a highlighted soft button 36 surrounding the text 224 for print job 24. Once a print job is selected in this manner, the user may perform control functions on the overall print job 24,25,26, or a sub-part 30,31 of a print job, either by using functions on the control bar 21, or by means of the soft keys 34 at the base of the “Printer Controller” window, which become activated upon the selection of highlighted text 224.

In this way, the overall status of a print job 24,25,26 and status of sub-parts 30,31 of split print jobs 24,26, can be conveniently monitored within the print queue 27, and controlled either at the level of the overall print job using the master status control indicator 124,126, or at the level of a sub-part 30,31 of the print job 24 using the associated sub-status control indicators 130,131, even though different print jobs and sub-parts of print jobs will in general be handled by different printers 10,11,12, or on the same printer at different times.

Referring now to FIG. 3, the process flow 40 of the invention can be summarized as follows. First one of the computers 2,3,4 is used 41 to create a print job 24,25,26. The computer 2,3,4 then determines 42 the requirements of the print job, and compares 43 these with the capabilities of the available printers 10,11,12. If the requirements are satisfied by a single printer capability 44, then there is no need to split the print job. If, however, the print job is not satisfied by a single printer capability 45, then it may be necessary or at least desirable to split 46 the print job according to the print requirements.

The or each print job 24,25,26 is then sent 47 to one or more of the printers 10,11,12, while status information is displayed 48 for the print job 24,25,26 including, for split print jobs, a master status control indicator 124,125,126, and associated sub-status control indicators 130,131 for sub-parts 30,31 of the print job.

Then, the user may use the mouse 17 and/or keyboard 16 to generate computer input in order to control the overall status of the print job 24,25,26, and for split print jobs 24,26 also the status of sub-parts 30,31 of the associated print job.

The invention therefore provides a convenient way of controlling such a multipart print job.

It is to be recognized that various alterations, modifications, and/or additions may be introduced into the constructions and arrangements of parts described above without departing from the spirit or scope of the present invention, as defined by the appended claims. In particular, the skilled person will recognize that there are ways other than illustrated in the preferred embodiment by which a master status control indicator can be graphically associated with sub-status control indicators.

1. A method of printing a print job in a printing system, the printing system comprising one or more printers and a computer system, the computer system being connected to the printers, wherein the computer system has a display for presenting to a user of the printing system print job status information, wherein the method comprises the steps of:
i) using the computer system to generate a multipart print job, said multipart print job being split into a plurality of sub-parts;
ii) sending the sub-parts of the multipart print job to one or more of the printers for printing; and
iii) displaying on the display, print job status information regarding the multipart print job;
wherein the print job status information comprises a master status control indicator for each multipart print job and associated with the master status control indicator a plurality of sub-status control indicators, one for each of the associated sub-parts of the multipart print job, so that a user of the printing system can control both the overall status of the print job and the status of each of said associated sub-parts.

2. The method of claim 1, in which the computer system includes a control input device, and the status control indicators for the multipart print job and associated sub-parts each include a control function, the control function being responsive to the control input device so that a user of the printing system may control the multipart print job via the control input device.

3. The method of claim 2, in which the control functions are each responsive to the control input device such that the overall multipart print job and the associated sub-parts of said multipart print job are all independently controllable by the user.

4. The method of claim 2, in which each control function is capable of any or all of: starting, pausing, cancelling, or re-starting the multipart print job or any of said sub-parts.

5. The method of claim 1, in which the status control indicators for the multipart print job and associated sub-parts each include an indication as to whether or not a multipart print job has started, and whether or not a started multipart print job has finished.

6. The method of claim 1, in which the computer system displays status information within windows on the display, and the master status control indicator and the associated sub-status control indicators are displayed in the same window.

7. The method of claim 1, in which the status information is displayed as a tree view.

8. The method of claim 1, in which each of the status control indicators may indicate any or all of: whether the associated multipart print job or sub-part of the print job has started; whether the associated multipart print job or sub-part of the multipart print job is pending; whether the associated multipart print job or sub-part of the multipart print job has finished.

9. A method of printing a print job in a printing system, the printing system comprising one or more printers and a computer system, the computer system being connected to the printers, wherein the computer system has a user display and the method comprises the steps of:
i) using the computer system to generate at least one print job including at least one multipart print job, said multipart print job being split into a plurality of sub-parts;
ii) sending the sub-parts of the multipart print job to one or more of the printers for printing; and
iii) displaying status information regarding said at least one print job on the display;
wherein the status information comprises: a master status control indicator showing the overall status of the or each print job; and for the or each multipart print job a plurality of sub-status control indicators associated with a corresponding master status control indicator.

10. The method of claim 9, in which the computer system has a data input device capable of interacting with said displayed status information, and the method comprises using the master status control indicator to control the overall status of at least one multipart print job.

11. The method of claim 10, in which the method comprises sing one or more of the sub-part status control indicators to control the status of at least one corresponding sub-part of the multipart print job.

12. A method of controlling multipart print job printing in a printing system, the printing system comprising one or more printers and a computer system, the computer system being connected to the printers, wherein the computer system has a display for presenting to a user printer status information, wherein the method comprises the steps of:
i) using the computer system to generate at least one multipart print job, said multipart print job being composed of a plurality of sub-parts;
ii) sending said sub-parts of the multipart print job to one or more of the printers for printing; and
iii) displaying on the display, status information regarding the multipart print job, wherein the status information comprises a user-interactive master status control indicator for the or each multipart print job and associated with the or each master status control indicator a plurality of user-interactive sub-status control indicators, one for each of the associated sub-parts of the multipart print job;
iv) using the computer system to control the printing of at least one multipart print job via an associated master status control indicator and/or via an associated sub-status control indicator.

13. A method of printing multipart print jobs in a printing system, the printing system comprising one or more printers and a computer system, the computer system being connected to the printers and having a user display, wherein the method comprises the steps of:
i) using the computer system to generate the multipart print job, said multipart print job being split into a plurality of sub-parts;
ii) sending the sub-parts of the multipart print job to one or more of the printers for printing; and
iii) displaying on the user display status information regarding the multipart print job, said status information comprising a master status control indicator for the multipart print job and a plurality of sub-status control indicators, one for each of said sub-parts, wherein each of said sub-status control indicators is graphically associated on the user display with the master status control indicator.

14. The method of claim 13, in which the status control indicators for the multipart print job and associated sub-parts each include an indication as to whether or not the multipart print job has started, and whether or not the started multipart print job has finished.

15. The method of claim 13, in which the computer system displays status information within windows on the display, and the master status control indicator and the associated sub-status control indicators are displayed in the same window.

16. The method of claim 13, in which the status information is displayed as a tree view.

17. The method of claim 13, in which each of the status control indicators may indicate any or all of: whether the multipart print job or a sub-part of the multipart print job has started; whether the multipart print job or sub-part of the multipart print job is pending; whether the multipart print job or sub-part of the print job has finished.

18. A printing system comprising one or more printers and a computer system, the computer system being connected to the printers, the computer system having a user display for presenting to a user of the system status information regarding a print job, wherein the computer system is operable to:
a) generate one or more print jobs at least one of which is a multipart print job split into a plurality of sub-parts;
b) send said sub-parts of the multipart print job to one or more of the printers for printing; and
c) display on the user display status information regarding said generated print job(s);
wherein the status information comprises a master status control indicator for the or each print job and associated with the master status control indicator of a multipart print job a plurality of sub-status control indicators, one for each of the sub-parts of the corresponding multipart print job.

19. A printing system comprising one or more printers and a computer system, the computer system being connected to the printers, the computer system having a user display for presenting to a user of the system status information regarding a print job, and a user-operable control device, wherein the computer system is operable to:
a) generate at least one multipart print job, said multipart print job being composed of a plurality of sub-parts;
b) send said sub-parts of the multipart print job to one or more of the printers for printing;
c) display on the user display status information regarding said multipart print job(s), wherein the status information comprises a user-interactive master status control indicator for the or each multipart print job and associated with the or each master status control indicator a plurality of user-interactive sub-status control indicators, one for each of the associated sub-parts of the multipart print job;
d) in response to user-operable control device, to control the printing of at least one multipart print job via an associated master status control indicator and/or via an associated sub-status control indicator.
